(19) United States
(12) Patent Application Publication
(10) Pub. No.: US 2012/0153576 A1
(43) Pub. Date: Jun. 21, 2012

(54) FLAT SEAL

(76) Inventor: Rolf Prehn, Wipperfurth (DE)

(21) Appl. No.: 13/391,053

(22) PCT Filed: Jun. 18, 2010
(86) PCT No.: PCT/DE2010/000696

§ 371 Date: Feb. 17, 2012

(30) Foreign Application Priority Data
Aug. 17, 2009 (DE) 102009037703.4

(51) Int. Cl. F02F 11/00

(52) U.S. Cl. 277/595; 277/594

(57) ABSTRACT

The invention relates to a flat seal, in particular an exhaust-gas-side seal, for an internal combustion engine, formed by an at least one-layer sealing element, which is provided with an opening, and a carrier element, which accommodates and guides the same with play and which is provided with screw through-holes, where the components that guide the sealing element project beyond the footprint of the carrier element, and the carrier element and/or the sealing element is provided with at least partially raised areas.

### BACKGROUND

1. Technical Field

The invention relates to an exhaust flange gasket for a combustion engine vehicle.

2. Related Art

Metal gaskets are currently being used for sealing tasks of this nature. The choice of material for this gasket type is based here on the maximum temperature or the continuous operating temperature. Due to the fact that modern engines and motors are placing ever greater demands on gasket technology, because both the combustion pressures and the combustion temperatures are increasingly constantly, ever higher quality materials need to be used to meet these challenges.

DE 10 2008 006 676 A1 describes a flat gasket, in particular an exhaust-side gasket for a combustion engine vehicle, formed by at least one single-layer seal fitted with a recess, consisting of a high quality, and in particular a highly temperature-resistant metallic material as well as a support accommodating the seal made from a lower quality metallic material, whereby the support accommodates the seal in such a way that the seal can be fixed and mounted. The connection between the seal and the support is mechanical via clamping, whereby the seal can be fitted with at least one set of all-round beading.

EP 0 955 489 B1 describes a metal seal with various surface pressure areas, containing a first, second and third metal plate, whereby the first and the second metal plates have ribbed areas, and the third metal plate is effectively connected to the first and second metal plates via flanging of an internal area.

JP 02286859 A is essentially a cylinder head gasket that has locking elements to accommodate layers in the media through-hole area.

US 2007/0090609 A1 describes a metallic seal consisting of multiple layers, including a first and a second metal plate as well as a connection section for partial connection of the first and second metal plate, as well as a third metal plate with an opening which is fitted onto a section adjacent to the connection section to house the connector.

EP 1 207 323 A2 has announced a cylinder head gasket for a combustion engine vehicle, including a first metal plate which covers primarily a complete area to be sealed and a first hole for the relevant cylinder hole and a second hole for a fluid hole. There is also an edge section where the first hole is positioned to define a third hole for the cylinder hole, whereby the edge section has a connector and the edge section is formed by a second metal layer consisting of a different material from the material used in the first metal plate.

EP 1 811 162 A1 relates to a metallic flat gasket for cylinder heads consisting of multiple layers and containing a number of through-holes. Next to the combustion chamber through-holes are outlets for cooling water and oil.

DE 10 2006 034 784 A1 describes a multi-layer, metallic flat seal, in particular a cylinder head gasket containing at least one combustion chamber opening and consisting of at least one seal layer. There is beading along the opening with at least one stopper layer and at least one stopper adjacent to the beading shaping that in cross-section consists of multiple mainly trapezoidal edges and recesses with angles and trapezoidal edges attached to both sides of the stopper layer in immediate succession.

### SUMMARY

An exhaust flange gasket is provided for a combustion engine vehicle, where the protrusion created by connecting the components can be compensated for using simple methods.

This task is solved by raised areas in the support area, namely in the area of the screw through-holes or in the support edge area associated in the seal, where the height is around the same as the components protruding beyond the basic area of the support, whereby the raised areas are created via single-sided or two-sided embossing of the support.

By bending the lugs fitted on the support and forming the components, the sealing system is thickened multiple times because there are then multiple layers on top of one another. This thickening can be minimised or corrected by compression or advance contouring of the contact surfaces (where the guide elements come into contact). In some cases, however, it is necessary to include the invented equipment here, namely the raised areas at least partially present.

The height equalisation of the mechanical bracing can be used to achieve the following:
the area immediately surrounding the screw through-holes with an embossed recess, for example (e.g. a type of half-beading), is raised,
the area immediately surrounding the sealing surface or the sealing area with an embossed recess (e.g. a type of half-beading), is raised,
the seal or the support in the area of at least two sealing surfaces (e.g. the engine block/cylinder head or engine block/exhaust manifold) via engraving (e.g. semi-spherical, square, bead-shaped or similar) is thickened on at least one point or across the entire surface itself. The raised areas thickened in this way are adjusted in terms of height to roughly the protrusion of the lug-shaped components.

The height equalisation can therefore be achieved using individual, e.g. embossed, raised sections in the support and/or in the seal or, however, using at least one beaded section formed all the way around, in particular embossed beading. This is the only way a second sealing line would be present, with which
the actual gasket can be strain-relieved in relation to the forces occurring in the tensioning process,
additional sealing can be created (using the second sealing line),
a stopper function can be implemented (e.g. for beading next to the stopper designs).

Using the height equalisation, any shifting movements occurring can be distributed across a smaller area. This helps to prevent friction. The friction and wear can also be minimised where necessary by coating these raised areas.

This gasket provides a type of hybrid solution, consisting of two different materials where required, whereby only the relative small sealing area subjected to higher temperatures is formed by a seal made from very high quality temperature-resistant material. A metal plate made from a considerably cheaper material can be used as a support for this seal; for the main task this plate is only used to realise the relevant insert thicknesses, where necessary connecting multiple seals together, and designing the entire gasket to be mountable and fixable.

Thanks to the targeted combination of appropriate materials, a considerable cost advantage over previous solutions can be achieved, as it is no longer necessary for the entire gasket to be made of high quality materials, but relevant materials only need to be used in the sealing areas in part.

The connection of the seal and the support should ideally be achieved mechanically via clamping.

A flat gasket as per the invention is preferable for use over an exhaust flange gasket.

The type of clamping can also be used to set whether and how much play (radial play) is present or should be present between the seal and the support. This means that differences relating to the thermal expansion response and the associated thermal tension between both materials should be compensated for.

Suitable materials for the sealing element include in particular Ni-Cr-Fe alloys, whereby other temperature-resistant alloys can also be used. The support may be made from standard steel, e.g. cold rolled band steel.

### THE DRAWINGS

Embodiments are shown in the drawings, in which:

FIGS. 1 to 3 show the basic structure of the flat gasket having the support element and the seal; and

FIGS. 4 and 5 are cross-sections via connection variants between the support and seal.

### DETAILED DESCRIPTION

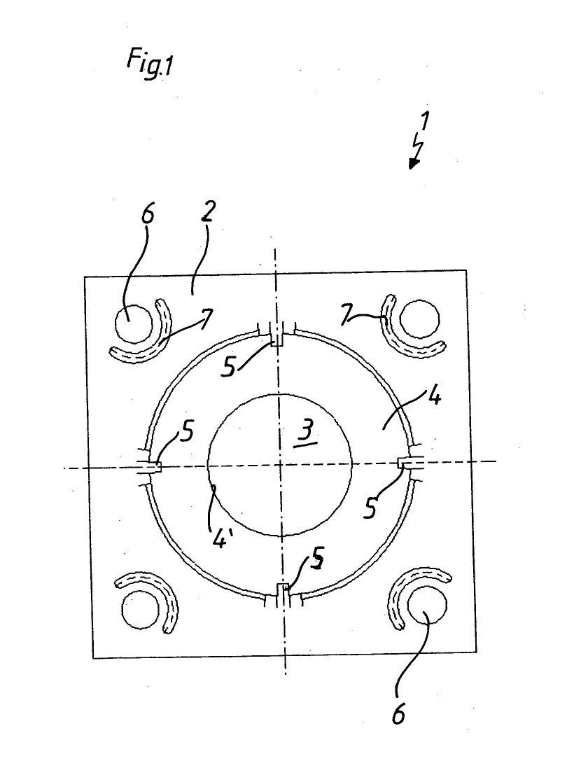

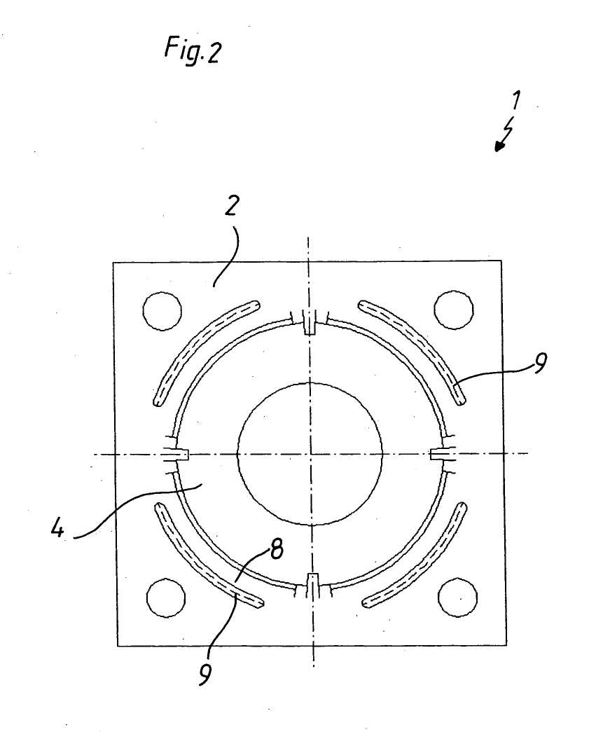

FIGS. 1 and 2 show alternative designs of the flat gasket 1 invention used as an exhaust flange gasket. The same components are fitted with the same reference marks. What is shown is a support 2, for example of cold rolled band steel, fitted with a hole 3. In this hole 3 there is a seal 4, containing a recess 4′, and formed from the support 2 via only outlined lugs 5 connected mechanically to the support 2 using a type of snap-on connection. The lugs 5 are expanded in the opposite direction so that some of them are positioned above and other below the seal 4. In this example, the seal 4 consists of a temperature-resistant Ni-Fe-Cr alloy and is placed into hole 3 in the support 2, designed to be easy to fix and mount.

In the example, in accordance with FIG. 1, there are raised areas 7 embossed in the form of half-beads close to the screw holes 6 in the support 2.

In the example, in accordance with FIG. 2, there are raised areas 9 embossed in the form of half-beads in the edge area 8 of the support 2 in the seal.

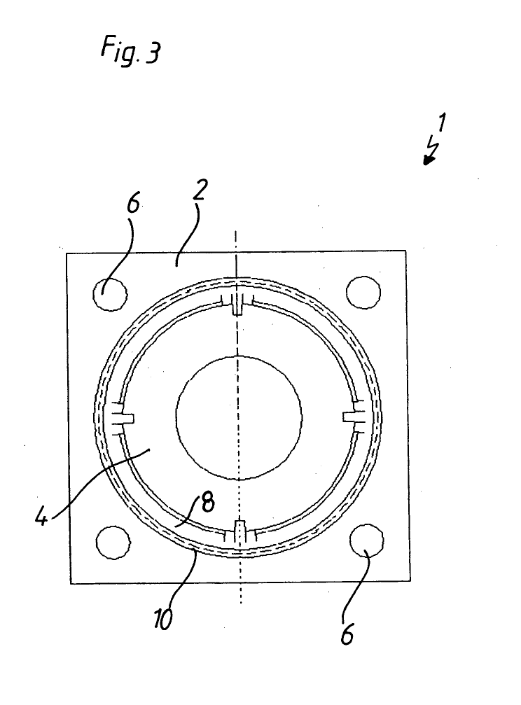

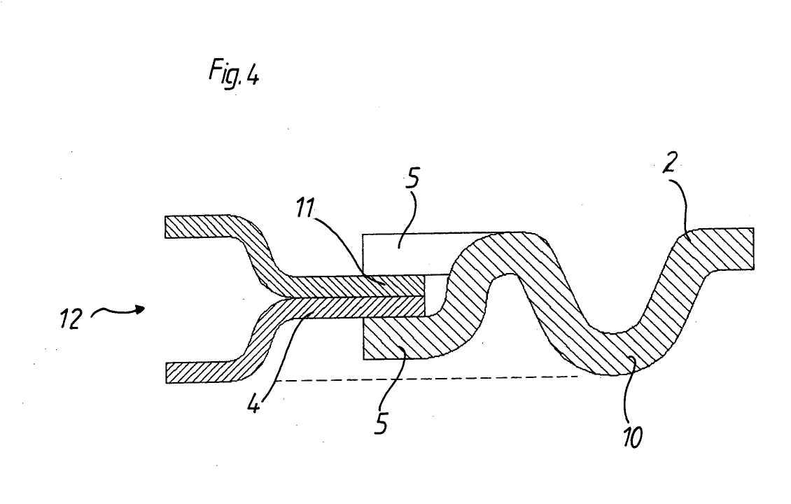

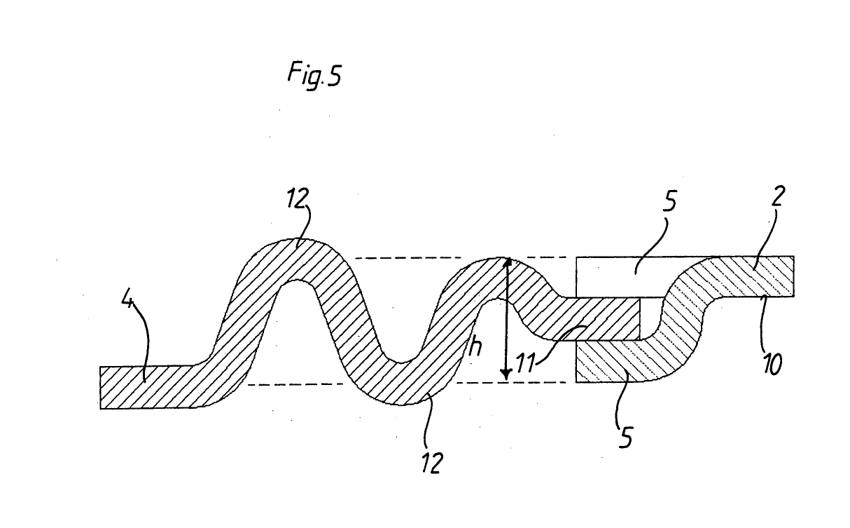

In the example, in accordance with FIG. 3, continuous all-round beading 10 is embossed in the support 2 between the screw holes 6 and the edge area 8. FIGS. 4 and 5 show cross-sections via connection variants between the support 2 and seal 4. What is shown in each case is the upper lugs 5 and the free side 11 of the seal 4, that is on the lower lugs 5 of the support 2. FIG. 5 shows an alternative support 2 as well as an alternative seal 4. Due to the deformation of the lugs 5, a protrusion outside the material thickness of the support 2 or of the seal 4 can be formed in the guide areas of the seal 4, that protrudes over the basic area of the support 2 by the defined height h. The seal 4 is outside the free side 11 with a beaded area 12.

Both the support 2 and the seal 4 are punched from suitable sheet-type primary products, whereby the hole 3 in support 2 corresponds to the external contour of the seal 4 being used. The lugs 5 are also punched on the hole side and expanded in the opposite direction. The seal 4 is placed onto individual lower lugs S and then the top lugs S are formed in the direction of the seal 2, so that—as shown in FIGS. 4 and 5—they are positioned on the free side 11 of the seal 4.

FIGS. 4 and 5 show the various cross-sections through FIG. 3. What is shown is the all-round beading 10 in each case in the area of the support 2. The beading 12, in accordance with FIG. 5, is designed so that it is positioned above the height h of the protruding lugs 5 over the free end 11 of the seal 4.

1. Flat gasket, in particular the exhaust-side seal, for a combustion engine vehicle, formed by a seal (4) with at least one layer and with a recess (4′) as well as an equivalent support (2) to absorb and direct play and fitted with screw holes (6), whereby the components (S) guiding the seal (4) protrude over the basic area of the support (2) and the support (2) and/or the seal (4) have raised areas at least in parts (7, 9, 10).

2. Flat gasket in accordance with claim 1, characterised in that the raised areas (7, 9, 10) are created via one-sided or two-sided embossing on the support (2) and/or the seal (4).

3. Flat gasket in accordance with claim 1 or 2, characterised in that the height (h) of the raised areas (7, 9, 10) corresponds roughly to that of the protruding components (S) in relation to the basic area (12) of the support (2).

4. Flat gasket in accordance with claims 1 to 3, characterised in that the raised areas (7, 9) are formed as a type of half-bead.

5. Flat gasket in accordance with claims 1 to 4, characterised in that there are raised areas (7) in the area of the screw holes (6).

6. Flat gasket in accordance with claims 1 to 5, characterised in that there are raised areas (9) in the edge area (8) of the support (2) adjacent to the seal (4).

7. Flat gasket in accordance with claims 1 to 5, characterised in that the raised areas (7, 9) are formed using circular segment embossed sections.

8. Flat gasket in accordance with claims 1 to 7, characterised in that the raised area (10) is formed using all-round beading in the support (2).

9. Flat gasket in accordance with claims 1 to 8, characterised in that the support (2) and the seal (4) consist of different metallic materials.

10. Flat gasket in accordance with claims 1 to 9, characterised in that the seal (4) consists of a temperature-resistant Ni-Cr-Fe material.

11. Flat gasket in accordance with claims 1 to 10, characterised in that the support (2) consists of steel, in particular, cold rolled band steel.

12. Flat gasket in accordance with claims 1 to 11, can be used as an exhaust flange gasket
